(19) United States
(12) Patent Application Publication
(10) Pub. No.: US 2012/0046782 A1
(43) Pub. Date: Feb. 23, 2012

(54) KINEMATIC APPROXIMATION ALGORITHM HAVING A RULED SURFACE

(76) Inventors: Jörg Schulze, Stuttgart (DE); Yayun Zhou, Munchen (DE)

(21) Appl. No.: 13/318,324

(22) PCT Filed: Apr. 19, 2010
(86) PCT No.: PCT/EP2010/055120

§ 371 Date: Oct. 31, 2011

(30) Foreign Application Priority Data
Apr. 29, 2009 (DE) 10 2009 019 443.6

(51) Int. Cl. G05B 19/4093

(52) U.S. Cl. 700/187

(57) ABSTRACT

In a method for producing at least one surface on a workpiece by a material removal tool and a corresponding material removal device, the surface is produced quickly and at low cost. Based on any surface to be produced, a movement path of the material removal tool is controlled to produce a ruled surface approximating to the surface, the movement path being provided in the form of a curve on a dual unit sphere, wherein a curve point corresponds to a location and an orientation of the removal tool. The curve can be produced based on ruling lines, which are converted into points, interpolated by a dual sphere spline interpolation algorithm, on the dual unit sphere by mathematical transformations. The curve can then be transformed back or can be used directly to follow the material removal tool. Likewise, directrix curves can be determined by the dual sphere spline interpolation algorithm.

### CROSS-REFERENCE TO RELATED APPLICATIONS

This application is a U.S. National Stage Application of International Application No. PCT/EP2010/055120 filed Apr. 19, 2010, which designates the United States of America, and claims priority to German Application No. 10 2009 019 443.6 filed Apr. 29, 2009. The contents of which are hereby incorporated by reference in their entirety.

### TECHNICAL FIELD

The present invention relates to a method for producing at least one surface on a workpiece by means of a material-removing tool and a corresponding material removal device.

### BACKGROUND

Workpieces can be, for example, components of technical machines, in particular turbomachines such as propellers, impellers of centrifugal compressors, rotors of pumps, gas turbines or turbochargers. Workpieces can be general parts to be machined.

Conventionally, the geometry design process and the manufacturing process are separate. During the design phase, engineers construct a ruled surface and deliver the surface to the manufacturing facility. A ruled surface can be optimized approximated to a free-form surface or optimized according to design requirements. In the manufacturing phase, particular methods for producing the ruled surface are applied. For example, five-axis flank milling involves the following steps: firstly, the milling tool contact paths are generated from the input surface data. Then, the milling tool positioning data is obtained from the milling tool contact data. Based on the milling tool positioning data, movement sequences for material-removing tools are planned. Finally, certain finishing operations are applied to obtain a numerical control code.

The prior art suffers from the following disadvantages: there is no global guarantee of continuity, several optimization loops are required, a loop calculation is costly, the time requirement is considerable, tool positioning data can contain local errors and adequate tool positioning data is required.

### SUMMARY

According to various embodiments, a method for creating an arbitrary surface on a workpiece can be created such that the surface is generated rapidly and economically. Any errors between an arbitrary surface to be created and a generated ruled surface must be small.

According to an embodiment, in a method for producing a surface on a workpiece by means of a material-removal too, based on an arbitrary surface to be created, a movement path of the material removal tool is controlled to create a ruled surface approximating to said arbitrary surface, wherein the movement path is provided in the form of a curve on a dual unit sphere, wherein a point on the curve corresponds to a location and an orientation of the material removal tool.

According to a further embodiment, the curve on the dual unit sphere can be defined as a continuous, smooth dual sphere spline curve. According to a further embodiment, the method may comprise—providing a sequence of discrete rulings approximating to an arbitrary surface to be created;—transforming coordinates of each discrete ruling in three-dimensional Euclidean space into coordinates of a discrete point on the dual unit sphere by means of a Klein mapping algorithm and thereafter, by means of a Study mapping algorithm;—interpolating the discrete points by generating a dual sphere spline curve having the discrete points using a dual sphere spline interpolation algorithm. According to a further embodiment, a ruling corresponds to the equation x(u₀,ν)=(1−ν)p(u₀)+νq(u₀); the dual sphere spline interpolation algorithm comprises the following equations: ŝ(u)=\tilde{Σ}ᵢ₌₁ⁿfᵢ(u)\hat{p}ᵢ, as the equation of the dual sphere spline curve, wherein fᵢ are basis functions and \hat{p}ᵢ are control points on the dual unit sphere in ID³, and

$${\sum }_{i = 1}^{n} {f}_{i} ( u ) = 1 , {f}_{i} ( u ) \geq 0 , ∀ i ,$$

fᵢ(u)≧0, ∀i, wherein weighted averages on the dual unit sphere correspond to the following equation: \hat{q}=\tilde{Σ}ᵢ₌₀ⁿωᵢ\hat{p}ᵢ

$${\sum }_{i} {ω}_{i} = 1 , {ω}_{i} \geq 0 ,$$

where ωᵢ≧0, wherein in order to generate the dual sphere spline curve, minimization can be carried out according to the following formula:

$$\hat{f} ( \hat{q} ) = \frac{1}{2} {\sum }_{i} {ω}_{i} \cdot {{dist}_{\hat{S}} ( \hat{q} , {\hat{p}}_{i} )}^{2} .$$

According to a further embodiment, calculation of the sequence of discrete rulings approximating to the arbitrary surface can be made by means of mathematical least-squares minimization of distances from the arbitrary surface. According to a further embodiment, the curve can be transformed, by means of an inverse Study mapping algorithm and thereafter by means of an inverse Klein mapping algorithm, into the ruled surface in three-dimensional Euclidean space. According to a further embodiment, the control points can be used as parameters for the approximation of the ruled surface to the arbitrary surface to be created. According to a further embodiment, the individual parameter u can be a feed rate or a time in relation to a displacement of the material removal tool. According to a further embodiment, based on the arbitrary surface to be created and the discrete rulings, in addition to each of the discrete rulings, a first and a second discrete reference straight line are determined, wherein a first discrete reference straight line extends through an intersection point of the discrete rulings with a first directrix curve to be determined and a second reference straight line extends through an intersection point of the rulings with a second directrix curve to be determined, and the orientations of said reference straight lines each correspond to the surface normals to the surface to be created at the intersection points, wherein a separation of the two intersection points of each discrete ruling corresponds to the length of the material removal tool; transforming the coordinates of each discrete reference straight line in three-dimensional Euclidean space into coordinates of a discrete point on the dual unit sphere by means of a Klein mapping algorithm and thereafter by means of a Study mapping algorithm, wherein a first discrete point sequence is generated for the first reference straight line sequence and for the second reference straight line sequence a second discrete point sequence is generated; interpolating the two discrete point sequences by generating two further dual sphere spline curves having the respective discrete point sequences by applying a dual sphere spline interpolation algorithm; converting all three dual sphere spline curves by means of an inverse Study mapping algorithm and then an inverse Klein mapping algorithm into three ruled surfaces in three-dimensional Euclidean space, wherein the two intersection lines of the two ruled surfaces of the first and second reference straight lines each define with the ruled surface of the rulings the first and second smooth and continuous directrix curve of the ruled surface of the rulings, and wherein the two directrix curves are mathematically described by p(u) and q(u) in the equation x(u,ν)=(1−ν)p(u)+νq(u).

According to a further embodiment, the method may comprise checking whether the movement path is within a working space of the material removal tool, making use of the kinematic properties of a required movement and making use of a robotic analysis. According to a further embodiment, the method can be used for a form design and/or for optimization of the form of the workpiece. According to a further embodiment, the material removal tool can be a component of a CNC (Computer Numerical Control) milling machine, and a wire-cut electric discharge machining apparatus or a laser cutting machine. According to a further embodiment, the workpiece can be a component of a turbomachine, for example, a propeller or a rotor.

According to another embodiment, in a device for carrying out a method as described above, a control device controls a material removal tool according to a method described above, wherein a computer device calculates a movement path of the material removal tool.

### BRIEF DESCRIPTION OF THE DRAWINGS

The present invention will now be described in greater detail on the basis of exemplary embodiments illustrated by the drawings, in which:

FIG. 1 is an exemplary embodiment of a ruled surface;

FIG. 2 is an exemplary embodiment of a product with ruled surfaces;

FIG. 3 is an exemplary embodiment of a method;

FIGS. 4a to 4d are a further exemplary embodiment of a method.

### DETAILED DESCRIPTION

A “ruled surface” is a surface that can be generated by moving a straight line in three-dimensional Euclidean space. In this way, a ruled surface can be easily created by material removal along a moved straight line. A straight line of a ruled surface can be designated a “ruling”. The material removal can be carried out, for example, by flank milling with a CNC (Computer Numerical Control) machine, wire-cut electric discharge machining or by laser machining.

According to a first aspect, a surface is created on a workpiece by means of a material removal tool wherein, based on an arbitrary surface to be created, a movement path of the material removal tool is controlled to create a ruled surface approximating to said arbitrary surface, wherein the movement path is provided in the form of a curve on a dual unit sphere, wherein a point on the curve corresponds to a location and an orientation of the material removal tool. A smoothed single-parameter path representation can be prepared relating to a displacement of the tool. This is an exact representation of the operation of a material removal device system. An analytical representation of the movement path of the material removal tool can be prepared, so that global error control is enabled for the production process. The theories of ruled surfaces are combined with screw theory and dual number algebra. Using the algorithm, any given surface or discrete straight line sequence, that is, milling tool positioning data, can be approximated by a ruled surface. The arbitrary surface to be created can be provided as a free-form surface or as discrete material removal tool positioning data. The arbitrary surface to be created can be, for example, aerodynamically optimized.

The advantages of a method according to various embodiments are: a smooth single parameter path representation with a curve on a dual unit sphere, in particular a dual sphere spline curve; a compact data structure for 5-axis milling with regard to position and orientation; continuity and convexity; simple judgment as to whether the tool lies within the working space or not; real time operation; global error checking and small kinematic errors; small quantity of cutting position data (CL data; cutter location data); suitable for various manufacturing processes.

According to a second aspect, a material removal device for carrying out a method according to various embodiments has a computer apparatus, a control device and the material removal tool. The material removal tool is controlled by means of the control device, specifically on the basis of the movement path calculated by the computer apparatus.

According to an embodiment, the curve can be defined on the dual unit sphere as a continuous, smooth spline curve. The spline curve can be designated a dual sphere spline curve. The curve can be defined on the dual unit sphere as a dual sphere spline. The continuity property of the spline avoids the need for a connection calculation in the conventional movement path representation. The calculation algorithm of the spline is fast enough for real time applications. A new type of spline is defined and designated a “dual sphere spline”. A ruled surface is represented as a dual sphere spline on the dual unit sphere. This spline has advantageous properties with regard to continuity and convexity. A point on this spline corresponds to a position and an orientation of a straight line in Euclidean space. The calculation of this spline is very rapid, so that a real-time requirement is fulfilled. This spline lessens the number of parameters to a third compared with conventional parameterization methods for ruled surfaces, such as, for example, the tensor-product B-spline surface.

According to a further embodiment, the following steps can be carried out to prepare the curve:
providing a sequence of discrete rulings approximating to an arbitrary surface to be created;
transforming coordinates of each discrete ruling in three-dimensional Euclidean space into coordinates of a discrete point on the dual unit sphere by means of a Klein mapping algorithm and thereafter by means of a Study mapping algorithm;
interpolating the discrete points by generating the spline curve having the discrete points using a dual sphere spline interpolation algorithm.

Based on the new type of spline, a series of algorithms for interpolating and calculating a dual sphere spline on the dual unit sphere is developed. Consequently, a kinematic ruled surface approximation algorithm is developed.

According to a further embodiment,
a ruling can correspond to the equation

x(u₀,ν)=(1−ν)p(u₀)+νq(u₀);
the dual sphere spline interpolation algorithm can comprise the following equations:

ŝ(u)=\tilde{Σ}ᵢ₌₁ⁿfᵢ(u)\hat{p}ᵢ,

as the equation of the spline curve, wherein fᵢ can be basis functions and \hat{p}ᵢ can be control points on the dual unit sphere in ID³, with

$${\sum }_{i = 1}^{n} {f}_{i} ( u ) = 1 , {f}_{i} ( u ) \geq 0 , ∀ i , \qquad ( 34 )$$

wherein
weighted averages on the dual unit sphere can represent the following equation:

$$\hat{q} = {\tilde{Σ}}_{i = 0}^{n} {ω}_{i} {\hat{p}}_{i} where {\sum }_{i} {ω}_{i} = 1 , {ω}_{i} \geq 0 , \qquad ( 17 )$$

wherein
in order to generate the spline curve, minimization can be carried out according to the following formula:

$$\hat{f} ( \hat{q} ) = \frac{1}{2} {\sum }_{i} {ω}_{i} \cdot {{dist}_{\hat{S}} ( \hat{q} , {\hat{p}}_{i} )}^{2} . \qquad ( 18 )$$

According to a further embodiment, calculation of the sequence of discrete rulings approximating to the arbitrary surface can be made by means of mathematical least-squares minimization of distances from the arbitrary surface.

According to a further embodiment, the curve can be transformed, by means of an inverse Study mapping algorithm and thereafter by means of an inverse Klein mapping algorithm, into the ruled surface in three-dimensional Euclidean space. This transformation is not required if a material machining device is able to convert the data of the curve directly into a movement path of the material removal tool.

According to a further embodiment, the control points can be used as parameters for the approximation of the ruled surface to the arbitrary surface to be created. A dual sphere spline can be defined by means of a plurality of control points. The spline can be determined by a plurality of control points. The control points can be used as parameters for an optimization.

According to a further embodiment, the individual parameter u can be a feed rate or a time in relation to a displacement of the material removal tool.

According to a further embodiment, the following steps can also be performed for determining directrix curves of the ruled surface defined on the basis of the rulings:
based on the arbitrary surface to be created and the discrete rulings, in addition to each of the discrete rulings, a first and a second discrete reference straight line are determined, wherein a first discrete reference straight line extends through an intersection of the discrete rulings with a first directrix curve to be determined and a second reference straight line extends through an intersection of the rulings with a second directrix curve to be determined, and the orientations of said reference straight lines each correspond to the surface normals to the surface to be created at the intersections, wherein a distance of the two intersection points of each discrete ruling corresponds to the length of the material removal tool;
transforming the coordinates of each discrete reference straight line in three-dimensional Euclidean space into coordinates of a discrete point on the dual unit sphere by means of a Klein mapping algorithm and thereafter, a Study mapping algorithm, wherein a first discrete point sequence is generated for the first reference straight line sequence and, for the second reference straight line sequence, a second discrete point sequence is generated;
interpolating the two discrete point sequences by generating two further dual sphere spline curves having the respective discrete point sequences by applying a dual sphere spline interpolation algorithm;
converting all three spline curves by means of an inverse Study mapping algorithm and then an inverse Klein mapping algorithm into three ruled surfaces in three-dimensional Euclidean space, wherein the two intersection lines of the two ruled surfaces of the first and second reference straight lines each define with the ruled surface of the rulings the first and second smooth and continuous directrix curve of the ruled surface of the rulings, and wherein the two directrix curves are mathematically described by p(u) and q(u) in the equation

x(u,μ)=(1−ν)p(u)+νq(u). (2)

According to a further embodiment, checking can be carried out of whether the movement path is within a working space of the material removal tool, making use of the kinematic properties of a required movement and making use of a robotic analysis.

According to a further embodiment, the method can be used for a form design and form optimization. Based on the reduction of the number of parameters compared with the prior art, the algorithm is preferably suitable for a use of this type.

According to a further embodiment, the material removal tool can be a component of a CNC (Computer Numerical Control) milling machine, a wire-cut electric discharge machining apparatus or a laser cutting machine.

According to a further embodiment, the workpiece can be a component of a turbomachine, for example, a propeller or a rotor.

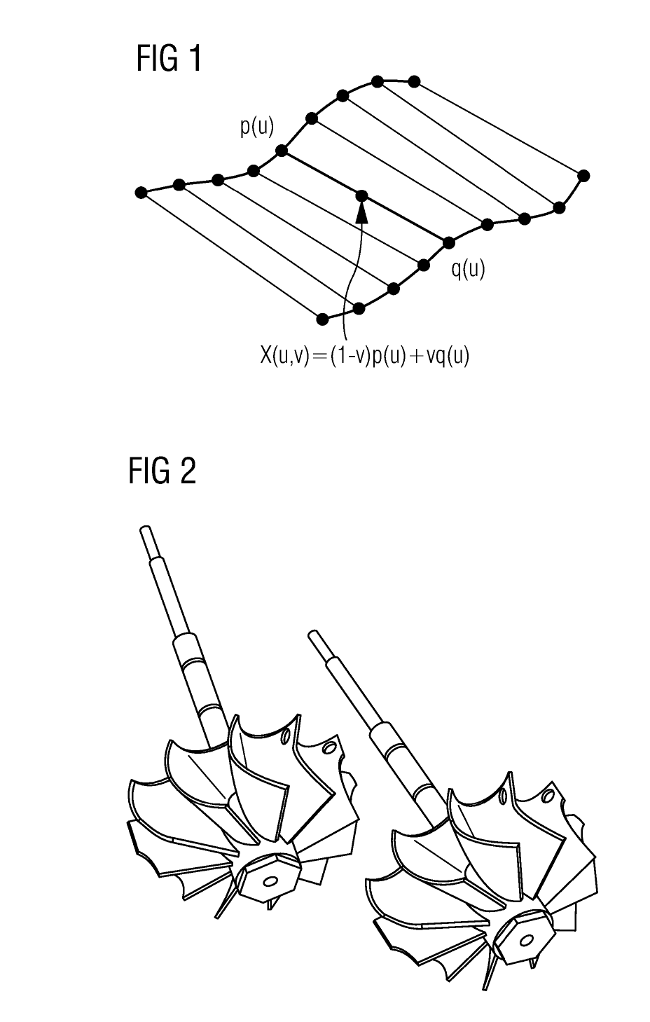

FIG. 1 shows an exemplary embodiment of a ruled surface. A ruled surface is defined in that the surface can be swept out by moving a straight line in Euclidean space. Ruled surfaces are simple and economical to generate and occur in many manufacturing processes.

A ruled surface is a preferred choice for production. A ruled surface is a special type of surface which can be created by moving a straight line in space. Ruled surfaces occur in various applications, such as wire-cut electric discharge machining (EDM) and laser cutting, which control the cutting tool as a moving straight line. It is also known that a ruled surface can be effectively created using a flank milling process with CNC-processing. In order to reduce the production costs, it is a typical design strategy to approximate a free-form surface as a ruled surface. There is consequently a need in industry for an effective ruled surface approximation algorithm.

A ruled surface is a simple object in geometric modeling. In the Euclidean space IR³, a ruled surface Φ has the following parametric representation:

x(u,ν)=a(u)+νr(u),u∈I,ν∈IR (1)

Where a(u) is designated the directrix curve and r(u) is a generation vector. Alternatively, a ruled surface Φ can be parameterized by two directrix curves p(u) and q(u):

x(u,ν)=(1−ν)p(u)+νq(u) (2)

The straight line defined as x(u₀,ν)=(1−ν)p(u₀)+νq(u₀) is designated a ruling. A ruled surface is a totality of straight one-parameter lines.

Although ruled surfaces have been intensively studied in classical geometry, they are not fully used for applications in geometrical design and production. The concepts of Bezier curves and surface design have been used for the construction of a ruled surface. The properties of ruled surfaces in line geometry have been studied in detail. In line geometry, a ruled surface is defined as a curve in a quadric in P⁵-space. On the basis of these properties, according to various embodiments, algorithms have been developed for the interpolation and approximation of ruled surfaces.

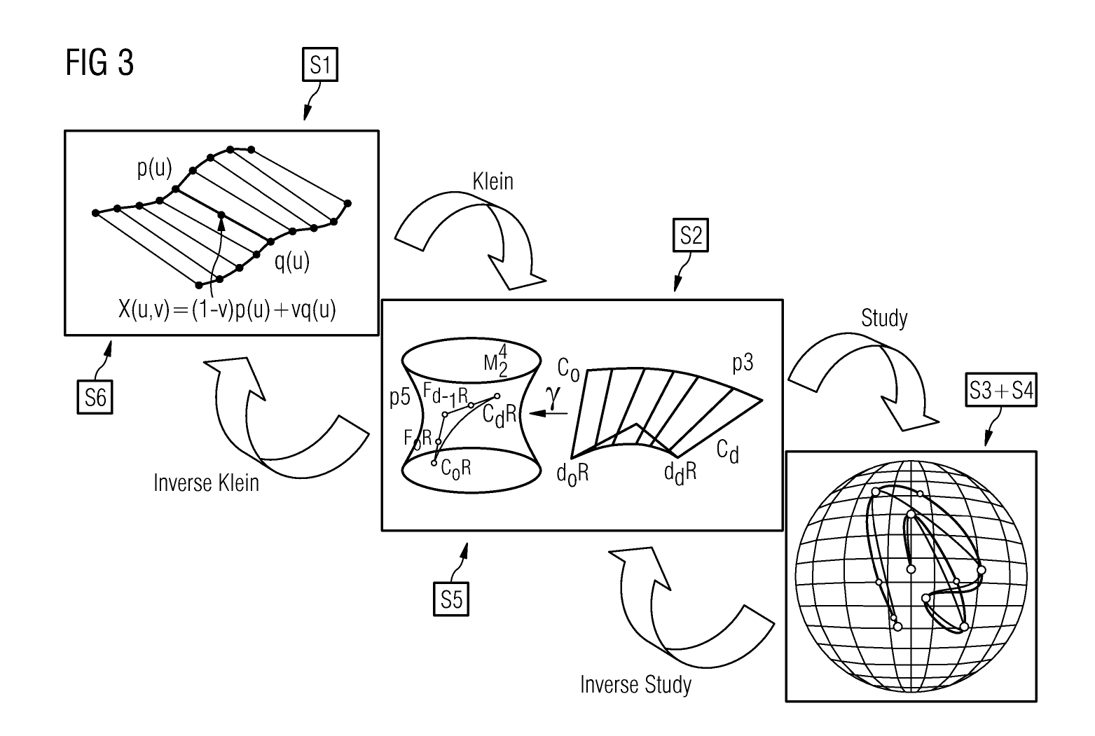

FIG. 2 shows an exemplary embodiment of a product with surfaces that can be approximated by means of ruled surfaces. Such surfaces can be, for example, surfaces of the blades of a turbine. Other products can be, for example, a propeller or a turbocharger.

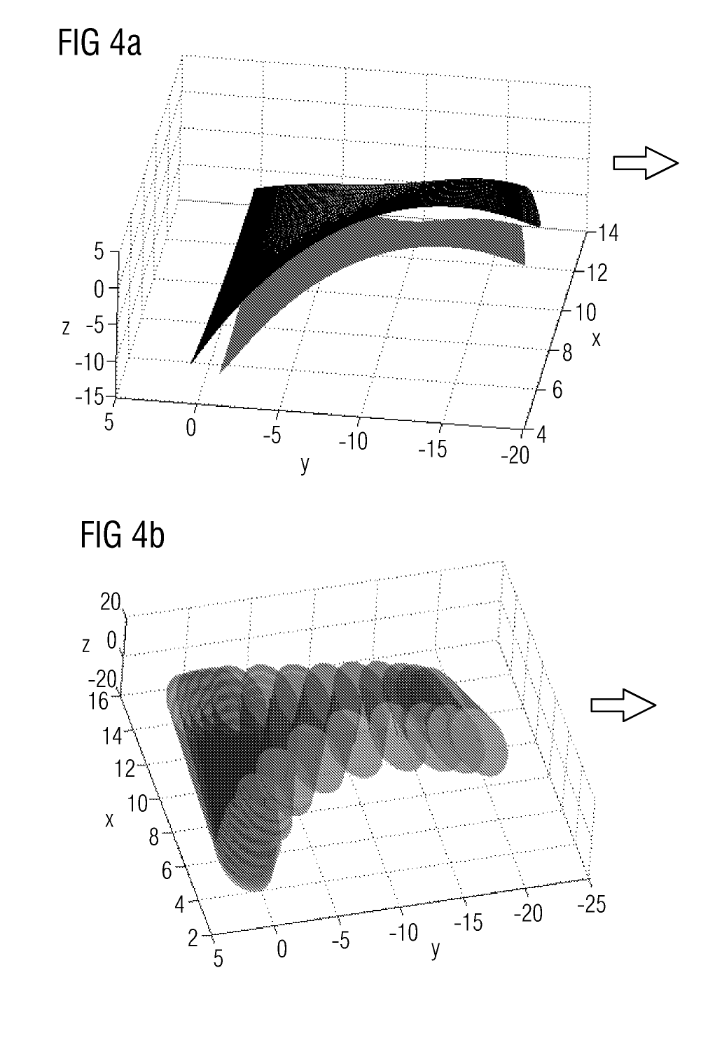

FIG. 3 shows an exemplary embodiment of a method. A sequence of discrete rulings approximating to an arbitrary surface to be created is provided. This is followed, in each case, by transformation of coordinates of a discrete ruling in three-dimensional Euclidean space into coordinates of a discrete point on the dual unit sphere by means of a Klein mapping algorithm and thereafter a Study mapping algorithm. This is followed by interpolation of the discrete points by generation of the dual sphere spline curve comprising the discrete points by applying a dual sphere spline interpolation algorithm:

Dual Sphere Spline and the Application thereof in a Ruled Surface Approximation

Using dual numbers to represent straight lines, a ruled surface is defined as a curve on a dual unit sphere (DUS). A method for calculating weighted averages on the DUS will be described, based on minimizing using a least squares method.

The presence, uniqueness, continuity and convexity properties of the weighted averages on the DUS will be discussed. This leads to a novel definition of a dual sphere spline on the DUS. A faster iterative algorithm for a dual sphere spline interpolation will be developed. On the basis of this algorithm, a kinematic ruled surface approximation algorithm will be established which approximates a free-form surface with a ruled surface. This method can be used for designing ruled surfaces and for approximating and planning a movement path of a tool, for example, for a computer numerical control (CNC) machine.

Conventionally, line geometry is used in kinematics together with screw theory in order to describe geometrical properties of the screw axis of a moving rigid body, and this then defines the production process for ruled surfaces. Making use of dual numbers, a ruled surface is described anew as a curve on a dual unit sphere (DUS). The kinematically generated ruled surface connects the path and the physical movement of the tool. An approximation algorithm based on this representation is not yet available. The key algorithm is based on linear interpolation of a general dual quaternion. It is the aim to approximate a given ruled surface with a cylindrical tool movement curve.

According to the present application, a new kinematic ruled surface approximation algorithm is introduced. This algorithm has been developed based on the dual number representation of a ruled surface. The problem of the approximation of the ruled surface in Euclidean space is converted into a curve approximation problem on the dual unit sphere. The difficulty of the curve approximation problem on the dual unit sphere is the non-linearity of the space. Conventional linear interpolation methods are not applicable in the space of the dual unit sphere.

Starting from the definition of the weighted average in real spherical space, firstly a weighted average on the dual unit sphere is defined. The weighted average on the dual unit sphere is defined as the result of minimizing according to the least squares method. This enables a novel method for defining Bezier and spline curves on the dual unit sphere. It has been shown that the problem of minimizing using the least squares method has a unique solution if the input points are situated on a dual hemisphere. The continuity and convexity properties of the dual sphere spline are also discussed.

Based on these definitions, a kinematic ruled surface approximation algorithm is developed. The essence of said algorithm is a fast algorithm for a dual sphere spline interpolation on the dual unit sphere. Said algorithm can be used for designing surfaces in different fields, in particular for turbomachines, such as propellers, the impeller of a centrifugal compressor, a gas turbine or a turbocharger. Said algorithm can also be used for designing the movement path and for planning tool movements in CNC machines.

The theoretical background to this approximation will now be described. Furthermore, novel definitions of a weighted average on the dual unit sphere, of a dual sphere Bezier curve and of a B-spline are proposed. In addition, an algorithm for calculating the weighted average on the dual unit sphere and a fast, iterative algorithm for dual sphere spline interpolation are provided. Furthermore, a kinematic ruled surface approximation algorithm for approximating a free-form surface with a ruled surface is proposed. Finally, a conclusion follows.

### Theoretical Background

Plücker Coordinates of a Straight Line

In homogeneous Cartesian coordinate systems, a straight line L can be represented algebraically with two different points: X=(x₀,x₁,x₂,x₃)R=(x₀,x)R and Y=(y₀,y₁,y₂,y₃)R=(y₀,y)R on the straight line:

L(t)=(1−t)X+tY (3)

Similarly, a straight line L can be represented in projective 3D-space P³ by the exterior product of two points X̂Y, which is designated the homogeneous Plücker vector coordinates) LIR=(l,l°)IR:

(1,1°=(x₀y−y₀x,x×y) (4)

In Euclidean space, i.e. x₀=y₀=1, the Plücker coordinates have a geometrical interpolation, wherein l=r=y−x and l°=x·r=x·y. These are the Plücker coordinates of an oriented straight line in E³. Clearly, these coordinate elements are not independent. Said coordinate elements satisfy the Plücker relation:

Ω_{q}(L)=I·I°=0 (5)

The homogeneous Plücker coordinates l,l° define a point in P⁵. The length of the vector l is arbitrary and can be unified:

l·l=1 (6)

Not every point in P⁵ is a Plücker coordinate. Only the points which satisfy the Plücker relation Equation 5 are Plücker coordinates. Equation 5 defines a quadratic manifold in P⁵, which is designated the Klein quadric M₂⁴. In this way, the bijection representation γ: L→M₂⁴ can be established between straight lines L∈P³ and points LIR∈M₂⁴. Said representation is designated “map” or “depiction”.

### Dual Number Representation of a Straight Line

A straight line can also be represented in a compact manner using dual numbers. A dual number can be written in the form â=a+εa°, where a, a°∈R and ε is the dual element such that ε²=0. Dual numbers can be expanded in the vector space, the space ID³ being defined as the set of all pairs of vectors:

â=a+εa° if a,a°∈IR³ (7)

Given two dual vectors, \hat{x}=x+εx° and ŷ=y+εy°, the inner product in ID³ is defined as follows:

\hat{x}·ŷ=x·y+ε(x°·y+x·y°) (8)

Consequently, the length of a dual vector is defined as

$$\vert \hat{x} \vert = {( x \cdot x )}^{\frac{1}{2}} + ɛ \frac{x \cdot x°}{x \cdot x} \qquad ( 9 )$$

A dual vector of length 1 is designated a dual unit vector. Clearly, a dual unit vector satisfies the following equations:

$$\{ \begin{matrix}x \cdot x = 1 \\ x \cdot x° = 0\end{matrix} \qquad ( 10 )$$

With regard to Equations 5 and 6, it is possible to obtain a more compact representation of a straight line: the dual number representation of a straight line is simply the Plücker coordinates written as a dual unit vector. The problem of calculating points on a quadric in P⁵ is reduced to a problem in a dual form of a spherical geometry. This representation or “map” is designated a Study map or Study depiction.

### Dual Number Representation of a Ruled Surface

Dual unit vectors define points on a sphere in ID³. Said sphere is designated the dual unit sphere (DUS). In this form, a ruled surface that has been defined by Equation 1 is written as a curve on the dual unit sphere:

$$\hat{L} ( u ) = 1 ( u ) + ɛ 1 ° ( u ) = \frac{r ( u )}{‖ r ( u ) ‖} + ɛ \frac{a ( u ) \times r ( u )}{‖ r ( u ) ‖} \qquad ( 11 )$$

A dual number representation of a ruled surface can be converted into an algebraic form:

x(u,v)=1(u)°+vl(u) (12)

Now a transformation construction is established between a ruled surface representation in Euclidean space and a curve representation on the dual unit sphere. In place of the solution of a surface approximation problem in Euclidean space, a curve approximation problem on the dual unit sphere is solved.

### Dual Sphere Spline

### Weighted Average and Spline on a Real Sphere.

A weighted average on a real sphere is defined, based on a minimization, according to the least squares method. Given that p₁, . . . , pₙ are points on a d-dimensional unit sphere S^{d} in IR^{d+1}, a weighted average of these n points uses weighting values ω₁, . . . , ωₙ such that each ωᵢ≧0 and

$${\sum }_{1} {ω}_{1} = 1 ,$$

the weighted average value is defined as:

C=\tilde{Σ}ᵢ₌₀ⁿωᵢpᵢ (13)

The weighted average value in Equation 13 is not simply a linear combination of the points p₁, . . . , pₙ, but rather the result of minimizing according to the least squares method, specifically as the point C on S^{d}, which minimizes the following value:

$$f ( C ) = \frac{1}{2} {\sum }_{i} {w}_{i} \cdot {{dist}_{S} ( C , {p}_{i} )}^{2} , \qquad ( 14 )$$

where distₛ(C, pᵢ) is the sphere separation between C and pᵢ. The function f reaches a clear minimum if the following condition is satisfied:

Theorem 1. Assuming the points p₁, . . . , pₙ all lie in a hemisphere H of S^{d}, with at least one point pᵢ in the interior of H with ωᵢ≠0. Then the function f has a single critical point C in H, wherein this point C is the global minimum of f.

It can be shown that the newly defined weighted average has advantageous properties. Based on the definition of a weighted average on a real sphere, the spline functions which assume values on the unit-d-sphere S^{d}, can be defined similarly. Now, given that p₁, . . . , pₙ are the points on S^{d} and that f₁(u), . . . , fₙ(u) are basis functions which fulfill the following property:

$${\sum }_{i = 1}^{n} {f}_{i} ( u ) = 1 , {f}_{i} ( u ) \geq 0 ∀ i \qquad ( 15 )$$

for u in the interval [a, b]. The spline curve s(u) which assumes the values on the unit sphere is defined as:

s(u)=\tilde{Σ}ᵢ₌₁ⁿfᵢ(u)pᵢ (16)

The commonest applications of splines use B-splines with the basis functions fᵢ(u), which are partially cubic curves with continuous second-order derivatives. It is known from a continuity theorem that if the basis functions f₁ have continuous k-t derivatives, the spline curve also has k-t derivatives. In said case, the sphere spline points s(t) are sufficiently well defined, provided that each of four successive control points lies in a hemisphere.

### Weighted Average on the Dual Unit Sphere

The transfer principle of dual unit vectors simply states that for each operation that is defined for a real vector space, a dual version with the same interpretation exists. Based on these transfer principles for dual unit vectors, a similar definition of a weighted average on the dual unit sphere can be derived. Since only the case of the dual unit sphere in ID³ is of interest, the definition can be narrowed down as follows:

Definition 1. There exist \hat{p}₁, . . . , \hat{p}ₙ on the dual unit sphere Ŝ² in ID³. A weighted average of these n points using real weighting values ω₁, . . . , ωₙ, so that each ωᵢ≧0 and Σᵢωᵢ=1, the weighted average of these n points is given by:

\hat{q}=\tilde{Σ}ᵢ₌₀ⁿωᵢ\hat{p}ᵢ (17)

It is defined as the result of minimizing using the least squares method, specifically as the point \hat{q} on Ŝ², which minimizes the following value:

$$\hat{f} ( \hat{q} ) = \frac{1}{2} {\sum }_{i} {ω}_{i} \cdot {{dist}_{\hat{S}} ( \hat{q} , {\hat{p}}_{i} )}^{2} \qquad ( 18 )$$

where dist_{Ŝ}(\hat{q},\hat{p}ᵢ) is the dual sphere spacing between \hat{q} and \hat{p}ᵢ.

The spacing between two points on the dual unit sphere is defined by a dual angle between two straight lines. This has the form \hat{θ}=θ+ε·d, where θ is the angle between the straight lines and d is the minimum spacing along the common perpendicular. For two points \hat{x} and ŷ on the dual unit sphere, the following equation results:

\hat{x}·ŷ=cos \hat{θ} (19)

The dual arccosine function is defined as:

$$\hat{θ} = {cos}^{- 1} ( x + ɛ {x}^{0} ) = {cos}^{- 1} ( x ) - ɛ \frac{x°}{\sqrt{1 - {x}^{2}}} \qquad ( 20 )$$

Similarly, the theorem exists for the presence and uniqueness of the definition.

Theorem 2: it is assumed that the points \hat{p}₁, . . . , \hat{p}ₙ all lie on a dual hemisphere Ĥ of Ŝ², with at least one point \hat{p}ᵢ in the interior of Ĥ where ωᵢ≠0. Then the function \hat{f} has a single critical point \hat{q} in Ĥ, wherein said point \hat{q} is the global minimum of \hat{f}.

### Presence (Existence) and Uniqueness

Theorem 2 will now be proved. Before the proof, the exponential and logarithmic functions for the dual vectors will be defined. These functions are useful for the proof and for the development of the algorithm.

### Exponential and Logarithmic Functions

Firstly a subspace of ID³ will be defined, which is expressed as follows:

T:={x|x=(\hat{x}₁,\hat{x}₂,0);\hat{x}₁,\hat{x}₂∈ID} (21)

The subspace T is clearly a linear space. The norm defined in Equation 9 is also valid for calculating the separation between two points in the subspace. This subspace can be taken to be a tangential hyperplane with respect to a point \hat{q} on the dual unit sphere. Without loss of generality, a point \hat{q}:=(0,0,1) is selected, wherein the points on the tangential plane of point \hat{q} can be written as \hat{x}:=(\hat{x}₁,\hat{x}₂,1). On the assumption that the point \hat{q} is the origin of T_{q}, what is obtained is precisely the subspace T. Then, the distance between \hat{q} and \hat{p}ᵢ on the hyperplane can be calculated as follows:

\hat{r}=∥\hat{x}−\hat{q}∥=∥\hat{x}₁,\hat{x}₂,0)∥ (22)

The exponential representation at \hat{q} is defined with the depiction of points from the tangential hyperplane T_{q} onto the dual unit sphere, which preserves angles and distances of \hat{q}. The exponential representation is designated exp \hat{q}(.). In this case a function is given which represents a point \hat{p} having the coordinates (\hat{x}₁, \hat{x}₂, 1) on a point exp_{\hat{q}}(\hat{p})=(\hat{x}′₁,\hat{x}′₂,\hat{x}′₃).

The following conditions should be fulfilled in order to preserve the distance:

\hat{x}′₃=cos(\hat{r}) (23)

where \hat{r} is defined by Equation 22. Since exp_{\hat{q}}(\hat{p}) is localized on the dual unit sphere, assuming the property sin²(\hat{r})+cos²(\hat{r})=1, the following is defined:

$${\hat{x}}^{′} = {\hat{x}}_{1} \cdot \frac{sin ( \hat{r} )}{\hat{r}} and {\hat{x}}_{2}^{′} = {\hat{x}}_{2} \cdot \frac{sin ( \hat{r} )}{\hat{r}} \qquad ( 24 )$$

In the case that r=0, the dual divisor is not defined, so that \hat{x}′₁=\hat{x}₁ and \hat{x}′₂=\hat{x}₂ are assigned.

The logarithmic function is the inverse function of the exponential representation, which maps a point \hat{P}′=(\hat{x}′₁,\hat{x}′₂,\hat{x}′₃) on the dual unit sphere onto a point (\hat{x}′₁, \hat{x}′₂, 1) on the tangential hyperplane T_{\hat{q}}, provided that \hat{p}′ is not antipodal to \hat{q}. We denote the logarithmic function as 1_{\hat{q}}(.) and exp_{\hat{q}}(1_{\hat{q}(\hat{p}′))=\hat{p}′ applies. Consequently the reverse mapping is defined as follows:}

$${\hat{x}}_{\dot{1}} = {\hat{x}}_{\dot{1}}^{′} \cdot \frac{\hat{θ}}{sin ( \hat{θ} )} ; for i = 1 , 2 , \qquad ( 25 )$$

wherein \hat{θ}=cos⁻¹(\hat{x}′₃) is the dual angle between \hat{p}′ and \hat{q}. It is assumed herein that the principal part of \hat{θ} fulfills the following inequality: 0≦θ<π. In the case of \hat{θ}=0, \hat{x}ᵢ=\hat{x}′ᵢ for i=1, 2.

### Proof of Existence

Since \hat{f} is a continuous function on the compact space Ŝ², \hat{f} reaches the minimum value at least at point \hat{q}. It can be shown that \hat{q} lies in the interior of the hemisphere Ĥ.

Under the assumption that \hat{q} is the minimum of Equation 18 and lies completely outside H, a point \hat{q}′ can be found in the interior of Ĥ, specifically by reflection of \hat{q} in the edge of Ĥ. Clearly for the point \hat{P}ᵢ within the hemisphere, the distance between \hat{P}ᵢ and \hat{q}′ is smaller than the distance between \hat{P}ᵢ and \hat{q}. For points \hat{P}ᵢ on the edge of Ĥ the distances are the same. The value of \hat{f}(\hat{q}′)<\hat{f}(\hat{q}) contradicts the assumption. Therefore the minimum \hat{q} cannot lie outside of Ĥ.

Next, it will be shown that the minimum \hat{q} also cannot lie on the edge of H. It is equally to be shown that the gradient of \hat{f} on the edge is always unequal to 0 and points out of Ĥ. Using the above mapping, \hat{F}(ŝ)=\hat{f}(exp_{\hat{q}}(ŝ) applies for the points ŝ on the tangential hyperplane T_{\hat{q}}. The axes \hat{x}ᵢ, \hat{x}₂ are selected for T_{\hat{q}} and then the first derivatives of \hat{f} are defined with

$$\hat{q} {ist ( \frac{\partial \hat{F}}{\partial {\hat{x}}_{i}} )}_{\hat{q}} .$$

The best description of the derivative of \hat{f} is the gradient vector ∇\hat{f}, which is a tangent vector to the dual sphere at \hat{q}:

$$∇ \hat{f} = {( \frac{\partial \hat{F}}{\partial {\hat{x}}_{1}} )}_{\hat{q}} {u}^{->} + {( \frac{\partial \hat{F}}{\partial {x}_{2}} )}_{\hat{q}} {{u}^{->}}_{2} \qquad ( 26 )$$

where \vec{u}₁ and \vec{u}₂ are the unit vectors oriented in the direction of the axes \hat{x}₁ and \hat{x}₂. For the proof of uniqueness, it is necessary to verify that the second derivative of \hat{f} is positive at the point \hat{q}. The second derivatives at \hat{q} are equal to

$${( \frac{{\partial }^{2} \hat{F}}{\partial {\hat{x}}_{i} \partial {\hat{x}}_{j}} )}_{\hat{q}} .$$

For the rest of the proof, screw theory calculations are used.

### Screw Theory

In the context of rigid body movements, a screw is one possibility for describing a displacement. The displacement can be considered to be a rotation about an axis and a translation along the same axis. A general screw Ŝ consists of two parts, a real 3-vector S, which gives the direction of the screw, and a true 3-vector Sₚ, which, by describing the moment of the screw about the origin, localizes Ŝ. In this regard, a screw is represented as a dual vector:

Ŝ=S+εSₚ=S+ε(pS+S₀) (27)

where p is the “pitch” of the screw and S₀ is the moment of the straight line of the screw about the origin. S₀ is derived from the origin radius vector R, or more generally, from each point V of the sphere with S₀=R×S=V×S. S₀ is perpendicular to S(S·S₀=0).

Evidently, a straight line is a screw in which the thread pitch is 0, i.e. p=0. Therefore screw calculations can be used to analyze the partial derivatives of the function \hat{f} at the point \hat{q} on the dual unit sphere. \hat{f} is a dual scalar function of the screw Ŝ, which has the following form:

\hat{f}(Ŝ)=\hat{f}(s+εs°) (28)

The argument with regard to the dual vectors is expressed, in an orthogonal coordinate system, with the origin point as 0, wherein the formulae are applied for a dual number argument. The dual coordinates of the screw are as follows:

Ŝₓ=sₓ+εs°ₓ,Ŝ_{y}=s_{y}+εs°_{y},Ŝ_{z}=s_{z}+εs°_{z} (29)

where sₓ, s_{y}, s_{z}, sₓ°, s_{y}°, s_{z}° are six real elements of a Plücker coordinate. Using the differential rules for dual number functions, the following is obtained:

$$\begin{matrix}\hat{f} ( {\hat{S}}_{x} , {\hat{S}}_{y} , {\hat{S}}_{z} ) = \hat{f} ( {s}_{x} + ɛ {s}_{x}^{∘} , {s}_{y} + ɛ {s}_{y}^{∘} , {s}_{z} + ɛ {s}_{y}^{∘} , {s}_{z} + ɛ {s}_{z}^{∘} ) \\ = \hat{f} ( {s}_{x} , {s}_{y} , {s}_{z} ) + ɛ ( {s}_{x}^{∘} \frac{\partial \hat{f}}{\partial {s}_{x}} + {s}_{y}^{∘} \frac{\partial \hat{f}}{\partial {s}_{y}} + {s}_{z}^{∘} \frac{\partial \hat{f}}{\partial {s}_{z}} )\end{matrix} \qquad ( 30 )$$

The function \hat{f} is real if all the variables are real, so that \hat{f}(sₓ, s_{y}, s_{z})=f(sₓ, s_{y}, s_{z}) applies. Following conversion into the vector notation, the following is obtained:

\hat{f}(Ŝ)=f(s)+εs°·∇f(s)=f(s)+ε(s°·∇)f(s) (31)

If the above equation is analyzed, it becomes apparent that the screw function \hat{f}(Ŝ) is completely defined by a function from the principal part thereof f(s). Resulting therefrom, is the following property: it is known that two dual vector functions F(\hat{x}) and φ(\hat{x}) fulfill the following equation:

∇F(x)=Φ(x) (32)

The following identity can be deduced:

∇F(\hat{x})=Φ(\hat{x}) (33)

As proof that the gradient of \hat{f} at the edge is always unequal to 0 and is directed outwardly from Ĥ, it is equally to be proved that the real vector function f(x) at the edge is always unequal to zero and is directed out of the real hemisphere H. This has already been shown in the literature. More generally, the following theorem is derived:

Theorem 3. All the formulae and all the theorems of vector analysis remain in effect in the field of screws.

It follows from the above that a screw analysis can be created by replacing screws in vectors. The relationship between geometrical objects, which was explained above, clearly remains: the dual “modulus” amount of the screw corresponds to the amount of the vector and the dual angle between the axes of the screws corresponds to the angle between vectors.

In place of the proof that the dual vector function \hat{f}(\hat{x}) has a clear minimum, it is shown that the main or “principal” part of f(x) has a clear minimum. Precisely the same sequence is followed as for the proof of the uniqueness of a weighted average on the real sphere. The proof will not be repeated here; the details can be found in the relevant literature.

### Continuity and Convexity Properties

It has been shown that the derivative property of a screw function is entirely determined by the principal part thereof. Consequently, the same continuity theorem is used as in the case of the real sphere:

Theorem 4. The values for \hat{p}₁, . . . , \hat{p}ₙ and ω₁, . . . , ωₙ and \hat{q} are chosen such that said values fulfill the hypotheses of Theorem 2. From this follows a neighborhood of in which the weighted average \hat{q} is a C^{∞}-function of \hat{p}₁, . . . , \hat{p}ₙ, ω₁, . . . , ωₙ.

It can also be shown that the points \hat{q}, which can be written as a weighted average of \hat{p}₁ . . . , \hat{p}ₖ, generate a convex set. They generate precisely the convex surface of the points \hat{p}₁, . . . , \hat{p}ₖ.

### Definition of Dual Sphere Splines

Based on the definition of a weighted average on the dual unit spheres in ID³, the spline functions which assume values on the dual unit sphere can be defined similarly. Exactly as with the definition of splines on a real sphere, the basis functions must always satisfy the following property:

$${\sum }_{i = 1}^{n} {f}_{i} ( u ) = 1 , {f}_{i} ( u ) \geq 0 , ∀ i \qquad ( 34 )$$

for u in the interval [a, b].

Since Bernstein polynomials and B-spline basis functions both fulfill this requirement, the dual sphere Bezier curve or B-spline curve ŝ(t) which assume values on the dual unit sphere are defined as follows:

ŝ(u)=\tilde{Σ}ᵢ₌₁ⁿfᵢ(u)\hat{p}ᵢ (35)

\hat{p}₁, . . . , \hat{p}ₙ are points on the dual unit sphere in ID³.

In order to meet the uniqueness requirement, for each value of the parameter u, the set of control points \hat{p}ᵢ for which fᵢ(u)≠0, is contained within a dual hemisphere. At least, each value is mostly contained within a hemisphere to fulfill the uniqueness conditions.

### Interpolation of Dual Sphere Splines

### Algorithm for Calculating Weighted Average Values on the Dual Unit Sphere.

A new algorithm for calculating the weighted average value on the dual unit sphere will now be proposed. The fundamental concept of the algorithm lies in the use of the logarithmic representation, which maps all the points \hat{p}ᵢ on the dual unit sphere on the tangential hyperplane at \hat{q}, then the weighted average thereof in the hyperplane is calculated and this result is mapped back onto the dual unit sphere by the exponential transformation. The exponential transformation is defined by Equations (23) and (24). The logarithmic transformation is defined by Equation (25). All the calculation rules are based on rules defined in the dual vector space ID³.

Since the exponential transformation and the logarithmic transformation are defined only with \hat{q}=(0,0,1), for a general point \hat{q} on the dual unit sphere, the coordinate frame must be moved so as to fit to the representation. The matrix for moving a point \hat{x}ᵢ to a point \hat{x}₂ on the dual unit sphere is given by the following formula:

$$\begin{matrix}{\hat{x}}_{2} = [ \hat{R} ] {\hat{x}}_{1} & ( 36 ) \\ where \\ \begin{matrix}[ \hat{R} ] = exp ( \hat{ω} [ ad \hat{g} ] ) \\ = [ I ] + sin ( ω ) [ ad \hat{g} ] + ( cos ( ω ) - 1 ) {( [ ad \hat{g} ] )}^{2}\end{matrix} & ( 37 )\end{matrix}$$

\hat{ω} determines the dual angle between the points \hat{x}ᵢ and \hat{x}₂:

\hat{x}₁·\hat{x}₂=cos \hat{ω}=x+εx° (38)

and the screw axis ĝ is selected so that said axis is perpendicular to both the points \hat{x}₁ and \hat{x}₂:

$$\hat{g} = \frac{{\hat{x}}_{1} \times {\hat{x}}_{2}}{‖ {\hat{x}}_{1} \times {\hat{x}}_{2} ‖} \qquad ( 39 )$$

The result is the following algorithm:
Algorithm for calculating weighted averages on the dual unit sphere.
Input: \hat{p}₁, . . . , \hat{p}ₙ on the dual unit sphere and non-negative direction factors ωᵢ, . . . ωₙ having a sum of 1;
Output: the weighted average of the input values;
Initialization: set \hat{q}:=Σᵢ₌₁ⁿωᵢ\hat{p}ᵢ/∥Σᵢ₌₁ⁿωᵢ\hat{p}ᵢ∥;
Main loop:
   for i=1; . . . ; n,
   set \hat{p}*ᵢ:=l_{\hat{q}}(\hat{p}ⁱ),
   set û:=Σᵢ₌₁ⁿω₁(\hat{p}*ᵢ−\hat{q})
   set \hat{q}:=exp_{\hat{q}}(\hat{q}+û),
      if the main value of ∥û∥ is sufficiently small, output \hat{q} and stop, otherwise continue the loop.

Here l_{\hat{q}}(\hat{p}ᵢ) is the transformation which maps the points to the tangential hyperplane at \hat{q} and exp_{\hat{q}}(\hat{q}+û) transforms the result back to the dual unit sphere.

### Algorithm for Spline Interpolation on the Dual Unit Sphere

Using the dual sphere spline defined in Equation (35), the dual sphere spline interpolation problem can be solved. Proceeding from the given points ĉ₁, . . . , ĉₙ on the dual unit sphere and from parameters u₁<u₂< . . . <uₙ′ a smoothing curve is to be found on the dual unit sphere, that is parameterized by u, specifically such that ŝ(uᵢ)=ĉᵢ for all i. The underlying problem is the selection of additional node positions and control points \hat{p}ᵢ that define a sphere spline curve according to Equation (35) and fulfill said conditions. \hat{f}ᵢ(u) is selected here as a cubic B-spline basis function and an iterative method for solving for the control points \hat{p}ᵢ is used. This can easily be expanded to B-splines of higher order.

According to the definition, there are n+2 control points for n input points. Let \hat{p}₁=\hat{p}₂ and \hat{p}ₙ₊₁=\hat{p}ₙ₊₂, wherein αᵢ, βᵢ, γᵢ denote the elements in a basis matrix that are not 0.

### Basis Matrix:

$$( \begin{matrix}1 & 0 & 0 & … & 0 & 0 \\ {α}_{2} & {β}_{2} & {γ}_{2} & 0 & … & 0 \\ 0 & {α}_{3} & {β}_{3} & {γ}_{3} & 0 & ⋮ \\ ⋮ & & ⋱ & ⋱ & ⋱ & 0 \\ 0 & … & 0 & {α}_{n - 1} & {β}_{n - 1} & {γ}_{n - 1} \\ 0 & 0 & … & 0 & 0 & 1\end{matrix} ) \qquad ( 40 )$$

The dual sphere cubic B-spline interpolation algorithm can be described as follows:

### Algorithm for Interpolation of Dual Sphere Cubic B-Splines:

Input: points ĉ₁; . . . ; ĉₙ and real coefficients
   αᵢ, βᵢ, γᵢ, (o≦i≦n);
Control points \hat{p}ᵢ;
Initialization: set \hat{p}ᵢ:=ĉᵢ for i=1, . . . n;
Main loop:
   for i=1; . . . ; n
   set \hat{p}*ᵢ₊₁:=−(αᵢ·l_{ĉ}_{ᵢ}(\hat{p}ᵢ)+γᵢ·l_{ĉ}_{ᵢ}(\hat{p}ᵢ₊₂))/βᵢ,
   set δᵢ=∥\hat{p}*ᵢ−l_{ĉ}_{ᵢ}(\hat{p}ᵢ,
set \hat{p}ᵢ₊₁:=exp_{ĉ}_{ᵢ}(\hat{p}*ᵢ),
set \hat{p}₁=\hat{p}₂ and \hat{p}ₙ₊₂=\hat{p}ₙ₊₁,
   if the sum of the principal values δᵢ of \hat{δ}ᵢ is sufficiently small, then the process is stopped; otherwise, running of the loop is continued.

When the control points are derived, the dual sphere spline is to be calculated as a weighted average of the control points. The running time of the weighted average algorithm is one order of magnitude smaller than the running time of the interpolation algorithm, so that the time for calculation of a large number of points along the curve dominates the time needed for calculation of the control points.

### Simulation Results

The algorithm was tested with different input values. The input line sequence is given in the form of dual vectors \hat{1}ᵢ=lᵢεl°ᵢ, where i=1, . . . , n. A point on the dual unit sphere corresponds to an infinite straight line in Euclidean space. To display the input straight line sequence, the dual vector representation of straight lines is transformed into the algebraic representation of straight lines:

lᵢ(v)=lᵢ×l°ᵢ+v·lᵢ, for i=1, . . . ,n (41)

v can be an element of the region [0,1]. In order to apply the interpolation algorithm for dual sphere cubic B-splines, the parameter sequence and node sequence must be determined. The chord length was selected for definition of the parameters: If \hat{d}ᵢ is the chord length between two given points \hat{d}ᵢ=\hat{l}ᵢ·\hat{l}ᵢ₋₁, i=1, . . . , n, then the overall chord length is calculated with \hat{d}=Σᵢ₌₁ⁿ\hat{d}ᵢ. Since \hat{d}ᵢ is a dual number, the principal part von \hat{d}ᵢ is used as dᵢ and the parameters are calculated as follows:

$${u}_{0} = 0 \\ {u}_{i} = {u}_{i - 1} + \frac{{d}_{i}}{d} , i = , … , n - 1 \\ {u}_{n} = 1 \qquad ( 42 )$$

This dual sphere spline allows the use of arbitrary node positions. For simplification, the node sequence is selected according to the parameters.

The algorithm converges rapidly and the interpolation error is small. The final result is given as a cubic dual sphere B-spline:

ŝ(u)=\tilde{Σ}ᵢ₌₁ⁿfᵢ(u)\hat{p}ᵢ

which satisfies the condition ŝ(uᵢ)=\hat{l}ᵢ. The dual cubic B-spline can be represented as a ruled surface, given by Equation 12, wherein λ∈[0,1]. The input line sequence and the points can be represented on the interpolated spline, given by ŝ(uᵢ). The algorithm was able to be verified.

### Kinematic Ruled Surface Approximation and Use Thereof

The dual sphere spline interpolation algorithm can be used to approximate a given free-form surface to a ruled surface. For the ruled surface approximation algorithm, the first step is finding a discrete system of rulings close to the given surface. Then this sequence of rulings which was derived in the first step is written in the form of dual vectors which correspond to points on the dual unit sphere. Then the dual sphere spline interpolation algorithm can be applied to derive a cubic B-spline curve on the dual unit sphere, corresponding to a ruled surface in Euclidean space. Said curve can be mapped back, based on Equation 12, to a ruled surface in Euclidean space. Two directrix curves on a ruled surface can be written as follows:

p(u)=l(u)×l(u)°+ν₁l(u) (43a)

q(u)=l(u)×l(u)°+ν₂l(u) (43b)

This representation contains two additional parameters ν₁ and ν₂ so that additional information is needed to determine the edges of the ruled surface. For different applications, a plurality of methods can be used. Herein a kinematic ruled surface approximation algorithm is proposed which is suitable, for example, for the design and production of centrifugal compressor blades.

In line geometry, a point can be interpreted as an intersection of two straight lines. A point on the edge of a ruled surface is defined by the intersection of a ruling with a reference straight line. More precisely, the reference straight line is defined in that said line extends through a point on a directrix curve and the orientation of the reference straight line agrees with the surface normals at this point. This definition of the reference straight line is inspired by the production process wherein the ruling, the normals to the area and/or surface and a unit vector perpendicular to the ruling and to the normals form a local coordinate system for the moving milling tool. Clearly, the movement of the reference straight line also generates a reference surface. Thus the dual sphere spline interpolation algorithm can be used as an input, making use of the reference straight line. A directrix curve is derived by intersecting the two ruled surfaces. Equally, the other directrix curve can be derived by repeating the above procedure.

The following steps can be performed for determining directrix curves of the ruled surface determined on the basis of the rulings:
starting from the arbitrary surface to be created and the discrete rulings, in addition to each discrete ruling, a first and a second reference straight line is determined, wherein a first discrete reference straight line extends through an intersection point of the discrete rulings with a first directrix curve to be determined and a second reference straight line through an intersection point of the reference straight line with a second directrix curve to be determined, and the orientations of each of said reference straight lines corresponds to the surface normals to the surface to be created at the intersection points, wherein a separation of the two intersection points of each of the discrete rulings corresponds to the length of the material removal tool;
transforming the coordinates of a discrete reference straight line in three-dimensional Euclidean space into coordinates, in each case, of a discrete point on the dual unit sphere by means of a Klein mapping algorithm and thereafter by means of a Study mapping algorithm, wherein a first discrete point sequence is generated for the first reference straight line sequence and a second discrete point sequence is generated for a second reference straight line sequence;

interpolating the two discrete point sequences by creating two further spline curves comprising the respective discrete point sequences by using a dual sphere spline interpolation algorithm;
converting all three spline curves by means of an inverse Study mapping algorithm followed by an inverse Klein mapping algorithm in three ruled surfaces in three-dimensional Euclidean space, wherein the two intersection lines of the two ruled surfaces of the first and second reference straight lines with the ruled surface of the rulings determine the first and second smooth and continuous directrix curve of the ruled surface of the rulings, and wherein the two directrix curves are mathematically described by p(u) and q(u) in the equation

x(u,ν)=(1−ν)p(u)+νq(u) (2).

In other words, the two directrix curves of the ruled surface assigned to the rulings are determined as follows, by way of example. A framework for the kinematic ruled surface approximation algorithm is obtained:

Step S1. Extraction of the rulings from the given surface and determination of the reference straight lines according to two directrix curves;

Step S2. Transformation of the coordinates of the three straight line sequences into the coordinates of the points on the dual unit sphere; transformation of coordinates of a discrete straight line in three-dimensional Euclidean space into coordinates of a discrete point on the dual unit sphere by means of a Klein mapping algorithm and then by means of a Study mapping algorithm;

Step S3. Application of the dual sphere B-spline interpolation algorithm;

Step S4. Calculation of the dual sphere B-spline with the algorithm of the dual sphere weighted average;

Step S5. Transformation of the dual number representation of the ruled surface back into Euclidean space; curves on the dual unit sphere can be transformed by means of an inverse Study mapping algorithm and then an inverse Klein mapping algorithm into a ruled surface in three-dimensional Euclidean space.

Step S6. Determination of the two directrix curves by intersecting ruled surfaces.

FIG. 3 shows the sequence of steps for determining a ruled surface which approximates to an arbitrary surface to be produced.

This algorithm was used, for example, for the design of blade surfaces. For verification of the algorithm, a centrifugal compressor blade which was designed approximating to a ruled surface was selected as the input for the algorithm. A simulation result for the kinematic spherical surface approximation algorithm was obtained. The original form of the selected blade can be imaged. Three sequences of straight lines which comprise one group of straight lines approximating to the given blade and two groups of normals can be extracted. These three groups of straight line sequences can be imaged. Using the dual sphere spline interpolation algorithm and the straight line intersection algorithm, an approximated ruled surface is derived. The approximated ruled surface can be compared with the originally given blade surface, from which it is apparent that the approximation error is very small. Said ruled surface is represented with a straight line path which generates the surface, so that a close connection to the production process is created.

### CONCLUSION

It has been described above how a ruled surface approximation problem in Euclidean space was transformed into a curve interpolation problem on the dual unit sphere by use of a Klein mapping algorithm and a Study mapping algorithm. A weighted average on the dual unit sphere was defined, which leads to the definition of a dual sphere spline on the dual unit sphere. Based on this definition, fast iterative algorithms for calculating the weighted averages and for interpolation of dual sphere splines on the dual unit sphere are proposed. These algorithms are defined with different inputs and are expanded into a kinematic ruled surface algorithm. This novel ruled surface algorithm can be used to approximate a free-form surface with a ruled surface. It can be used for designing surfaces and for planning tool paths, for example in CNC machines. The kinematic ruled surface approximation algorithm therefore has a high value for industrial production and possesses many application possibilities in a variety of fields. Arbitrary surfaces can be created on arbitrary materials.

A method according to the main claim is adequate for workpiece machining, since the tool has only one particular length and, in this way, a ruled surface is created. According to various embodiments' the directrix curves can also be determined. Furthermore, a material machining device can use the data from the dual sphere spline curve directly to create a ruled surface. Material machining following transformation into a ruled surface in Euclidean space is also possible. The arbitrary surface to be created can be aerodynamically optimized, determined by structural data, by experiment or by means of other criteria. A curved surface can be produced.

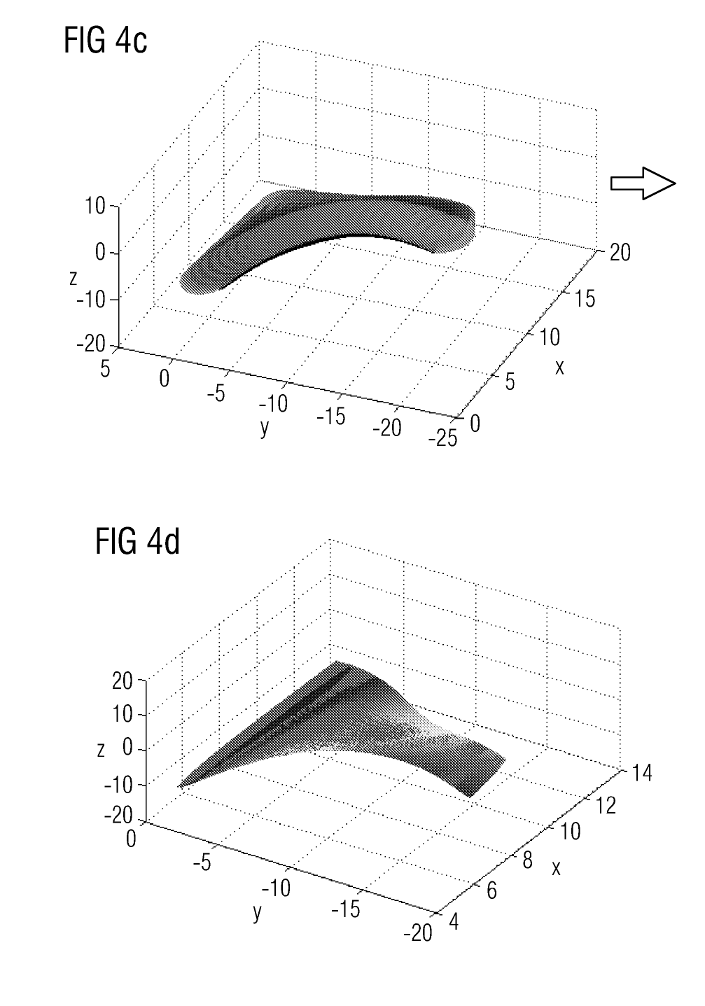

FIGS. 4a to 4d show a further embodiment of a method. FIGS. 4a to d show the control of a flank milling apparatus by means of computer numerical control (CNC). FIG. 4a shows, in a first step, a lower surface to be created and an offset surface. FIG. 4b shows, in a second step, the discrete positions of the material removal tool. FIG. 4c shows, in a third step, the movement of the material removal tools and the surface created. FIG. 4d shows a comparison between the surface produced and a defined blade as the surface to be produced.

What is claimed is:

1. A method for producing a surface on a workpiece by means of a material-removal tool, comprising:
based on an arbitrary surface to be created, controlling a movement path of the material removal tool to create a ruled surface approximating to said arbitrary surface, wherein the movement path is provided in the form of a curve on a dual unit sphere, wherein a point on the curve corresponds to a location and an orientation of the material removal tool.

2. The method according to claim 1, wherein the curve on the dual unit sphere is defined as a continuous, smooth dual sphere spline curve.

3. The method according to claim 2, comprising providing a sequence of discrete rulings approximating to an arbitrary surface to be created;
transforming coordinates of each discrete ruling in three-dimensional Euclidean space into coordinates of a discrete point on the dual unit sphere by means of a Klein mapping algorithm and thereafter, by means of a Study mapping algorithm;
interpolating the discrete points by generating a dual sphere spline curve having the discrete points using a dual sphere spline interpolation algorithm.

4. The method according to claim 3, wherein
a ruling corresponds to the equation
x(u₀,ν)=(1−ν)p(u₀)+νq(u₀)
the dual sphere spline interpolation algorithm comprises the following equations:
ŝ(u)=\tilde{Σ}ᵢ₌₁ⁿfᵢ(u)\hat{p}ᵢ, (35)
as the equation of the dual sphere spline curve, wherein fᵢ are basis functions and \hat{p}ᵢ are control points on the dual unit sphere in ID³, and
$${\sum }_{i = 1}^{n} {f}_{i} ( u ) = 1 , {f}_{i} ( u ) \geq 0 , ∀ i ,$$
wherein
weighted averages on the dual unit sphere correspond to the following equation:
$$\hat{q} = {\tilde{Σ}}_{i = 0}^{n} {ω}_{i} {\hat{p}}_{i} where {\sum }_{i} {ω}_{i} = 1 , {ω}_{i} \geq 0 ,$$
wherein
in order to generate the dual sphere spline curve, minimization can be carried out according to the following formula:
$$\hat{f} ( \hat{q} ) = \frac{1}{2} {\sum }_{i} {ω}_{i} \cdot {{dist}_{\hat{S}} ( \hat{q} , {\hat{p}}_{i} )}^{2}$$

5. The method according to claim 3, wherein calculation of the sequence of discrete rulings approximating to the arbitrary surface is made by means of mathematical least-squares minimization of distances from the arbitrary surface.

6. The method according to claim 1, wherein the curve is transformed, by means of an inverse Study mapping algorithm and thereafter by means of an inverse Klein mapping algorithm, into the ruled surface in three-dimensional Euclidean space.

7. The method according to claim 4, wherein the control points are used as parameters for the approximation of the ruled surface to the arbitrary surface to be created.

8. The method according to claim 4, wherein the individual parameter u is a feed rate or a time in relation to a displacement of the material removal tool.

9. The method according to claim 3, wherein based on the arbitrary surface to be created and the discrete rulings, in addition to each of the discrete rulings, a first and a second discrete reference straight line are determined, wherein a first discrete reference straight line extends through an intersection point of the discrete rulings with a first directrix curve to be determined and a second reference straight line extends through an intersection point of the rulings with a second directrix curve to be determined, and the orientations of said reference straight lines each correspond to the surface normals to the surface to be created at the intersection points, wherein a separation of the two intersection points of each discrete ruling corresponds to the length of the material removal tool;
transforming the coordinates of each discrete reference straight line in three-dimensional Euclidean space into coordinates of a discrete point on the dual unit sphere by means of a Klein mapping algorithm and thereafter by means of a Study mapping algorithm, wherein a first discrete point sequence is generated for the first reference straight line sequence and for the second reference straight line sequence a second discrete point sequence is generated;
interpolating the two discrete point sequences by generating two further dual sphere spline curves having the respective discrete point sequences by applying a dual sphere spline interpolation algorithm;
converting all three dual sphere spline curves by means of an inverse Study mapping algorithm and then an inverse Klein mapping algorithm into three ruled surfaces in three-dimensional Euclidean space, wherein the two intersection lines of the two ruled surfaces of the first and second reference straight lines each define with the ruled surface of the rulings the first and second smooth and continuous directrix curve of the ruled surface of the rulings, and wherein the two directrix curves are mathematically described by p(u) and q(u) in the equation
x(u,ν)=(1−ν)p(u)+νq(u).

10. The method according to claim 1, comprising checking whether the movement path is within a working space of the material removal tool, making use of the kinematic properties of a required movement and making use of a robotic analysis.

11. The method according to claim 1, wherein the method is used for at least one of a form design and optimization of the form of the workpiece.

12. The method according to claim 1, wherein the material removal tool is a component of a Computer Numerical Control (CNC) milling machine, and a wire-cut electric discharge machining apparatus or a laser cutting machine.

13. The method according to claim 1, wherein the workpiece is a component of a turbomachine or a propeller or a rotor.

14. A device for producing a surface on a workpiece by means of a material-removal tool, comprising:
a control device operable to control a material removal tool, based on an arbitrary surface to be created, to create a ruled surface approximating to said arbitrary surface, wherein a computer device calculates a movement path of the material removal tool such that a movement path is provided in the form of a curve on a dual unit sphere, wherein a point on the curve corresponds to a location and an orientation of the material removal tool.

15. The device according to claim 14, wherein the curve on the dual unit sphere is defined as a continuous, smooth dual sphere spline curve.

16. The device according to claim 15, comprising providing a sequence of discrete rulings approximating to an arbitrary surface to be created;
transforming coordinates of each discrete ruling in three-dimensional Euclidean space into coordinates of a discrete point on the dual unit sphere by means of a Klein mapping algorithm and thereafter, by means of a Study mapping algorithm;
interpolating the discrete points by generating a dual sphere spline curve having the discrete points using a dual sphere spline interpolation algorithm.

17. The device according to claim 16, wherein
a ruling corresponds to the equation
x(u₀,ν)=(1−ν)p(u₀)+νq(u₀);
the dual sphere spline interpolation algorithm comprises the following equations:
ŝ(u)=\tilde{Σ}ᵢ₌₁ⁿfᵢ(u)\hat{p}ᵢ,
as the equation of the dual sphere spline curve, wherein fᵢ are basis functions and \hat{p}ᵢ are control points on the dual unit sphere in ID³, and
$${\sum }_{i = 1}^{n} {f}_{i} ( u ) = 1 , {f}_{i} ( u ) \geq 0 , ∀ i ,$$
wherein
weighted averages on the dual unit sphere correspond to the following equation:
$$\hat{q} = {\tilde{Σ}}_{i = 0}^{n} {ω}_{i} {\hat{p}}_{i} where {\sum }_{i} {ω}_{i} = 1 , {ω}_{i} \geq 0 ,$$
wherein
in order to generate the dual sphere spline curve, minimization can be carried out according to the following formula:
$$\hat{f} ( \hat{q} ) = \frac{1}{2} {\sum }_{i} {ω}_{i} \cdot {{dist}_{\hat{S}} ( \hat{q} , {\hat{p}}_{i} )}^{2} .$$

18. The device according to claim 16, wherein calculation of the sequence of discrete rulings approximating to the arbitrary surface is made by means of mathematical least-squares minimization of distances from the arbitrary surface.

19. The device according to claim 14, wherein the curve is transformed, by means of an inverse Study mapping algorithm and thereafter by means of an inverse Klein mapping algorithm, into the ruled surface in three-dimensional Euclidean space.

20. The device according to claim 17, wherein the control points are used as parameters for the approximation of the ruled surface to the arbitrary surface to be created.
